(19) United States
(12) Patent Application Publication
(10) Pub. No.: US 2004/0048055 A1
(43) Pub. Date: Mar. 11, 2004

(54) Continuous fiber composite reinforced synthetic wood elements

(76) Inventor: Alfonso Branca, Milan (IT)

Correspondence Address: TIMOTHY S. STEVENS, 5108 FOX POINT, MIDLAND, MI, 48642, US

(21) Appl. No.: 10/242,187

(22) Filed: Sep. 11, 2002

(51) Int. Cl. B32B 27/04

(52) U.S. Cl. 428/297.4

(57) ABSTRACT

A synthetic wood structural member having at least one continuous fiber composite reinforcing rod element positioned within it to increase the stiffness of the member. The longitudinal axis of the continuous fiber composite reinforcing rod element is essentially parallel to the longitudinal axis of the synthetic wood structural member.

### BACKGROUND

There exist many products, technologies and ideas to use extruded or molded thermoplastics as an alternative to wood in semi-structural outdoor applications such as decking, park walkways, children's playgrounds, seats and benches. The thermoplastic most widely used is polyethylene, typically a recycled product from HDPE, LDPE & LLDPE milk bottles, film etc. Other thermoplastics widely used include PVC and polypropylene. Many systems also use a filler, typically wood or other natural fibers, compounded into the thermoplastic to enhance properties and make the compound look more like the wooden planks it replaces. Some systems also have discontinuous glass fibers added to the synthetic wood to further enhance properties. In this document all these compounds will be referred to as “synthetic wood” though they are often also called “wood composites”, “plastic wood” or “composite wood”. These systems are rapidly gaining market acceptance, especially in decks where they have advantages of long-term durability and lack of maintenance. They have an additional advantage because of recent health concerns regarding the chemicals and preservatives used to treat wood for outdoor applications. However, these synthetic wood or wood composite products have a major disadvantage when their mechanical properties, especially strength and stiffness are compared with the wood they replace: Wood, depending on the species and grade has a modulus of 1-2 million pounds per square inch (psi). Polyethylene has a modulus only 1/10 that of wood. Even when wood fibers are added to the polyethylene the modulus is still far below that of solid wood. Further, because these wood composites have a thermoplastic matrix they are susceptible to creep when subjected to continuous loads and/or high ambient temperatures. Because of these structural limitations the use of synthetic wood is restricted to less structural applications—e.g. in decks it is used for deck boards but typically cannot be used for the vertical posts and joists that bear the loads of the whole structure.

It is desirable therefore to have a means to reinforce and increase the stiffness of these synthetic wood components to allow them to be used as a direct structural replacement for wood. Further since one of the key reasons for the use of synthetic lumber is to increase the durability of the structure it is desirable to avoid the use of steel fasteners that may corrode.

### SUMMARY OF THE INVENTION

This invention describes a means to reinforce and enhance the performance of synthetic wood components using continuous fiber reinforced composites incorporated longitudinally into the component as it is produced. A synthetic wood component comprising a synthetic wood polymer, with or without natural fiber filler, is extruded incorporating one or more continuous fiber reinforcing rod elements aligned essentially parallel to the longitudinal axis of the component. The addition of these continuous fiber reinforcing rod elements greatly enhances the modulus of the resulting synthetic wood components. The higher modulus thus obtained makes it possible to use the synthetic wood component as a primary structural element in decks or other structures.

In another embodiment, the instant invention is a method of fixing or jointing wood or synthetic wood elements avoiding the use of metal fasteners. One or more continuous fiber reinforced composite dowel elements are tightly inserted into holes in the wood to hold them together in position. The friction from the tight fit of the dowel into the hole combined with the high stiffness of the composite used for the dowel element create a durable, long lasting joint not prone to corrosion.

### BRIEF DESCRIPTION OF THE DRAWINGS

FIG. 1A is a perspective view showing alternative shapes of continuous fiber composite reinforcing rod elements;

FIG. 1B is a perspective view showing continuous fiber composite reinforcing rod elements with over-extruded polymer layers;

FIG. 1C is a perspective view showing continuous fiber composite reinforcing rod elements with over-extruded polymer layers and perturbations formed into the surface of the over-extruded polymer to enhance bond with the synthetic wood;

FIG. 2 shows cross sections through decking boards indicating placement of continuous fiber composite profiles and potential hollowed out sections for weight saving;

FIG. 3 shows a cross section through a joist or header indicating placement of continuous fiber composite reinforcing rod elements and potential hollowed out sections for weight saving;

FIG. 4 shows a cross section through a post, indicating placement of continuous fiber composite reinforcing rod elements and potential hollowed out sections for weight saving.

FIG. 5 shows a detail of the cross section through a deck board, joist, header or post showing an area to be identified to avoid nails or other fasteners;

FIG. 6 is a perspective view showing the method of using composite dowels to join components;

FIG. 7A shows a cross section through a post and joist showing the use of composite dowels with end screws to enhance joint durability; and

FIG. 7B shows a cross section through a post and joist showing the use of composite dowels implanted at an angle to enhance joint durability.

### DETAILED DESCRIPTION OF THE INVENTION

Many means exist to produce synthetic wood. Two such means are described in U.S. Pat. No. 5,486,553 in which wood fibers are compounded with PVC and subsequently used to make components by extrusion or injection molding and U.S. Pat. No. 5,516,472 in which cellulosic fibers are combined with a thermoplastic and other additives and the resulting compound extruded into strands which are subsequently compressed together to form a profile. Both of these and the many other means of producing synthetic wood compounds and components from synthetic wood compounds suffer from the disadvantage that the resulting material and components made from it lack the properties of the solid wood or engineered lumber components for which it is desirable to use them as replacements. As a result these synthetic wood components need to be designed and specified for lower load conditions, or greater deflections need to be acceptable in the end use application. In particular for decks they cannot be used for the structure of the deck i.e. vertical posts, beams and joists.

The present invention overcomes the deficiency of low stiffness of the existing systems by incorporating rods or other profiles of continuous fiber composite materials.

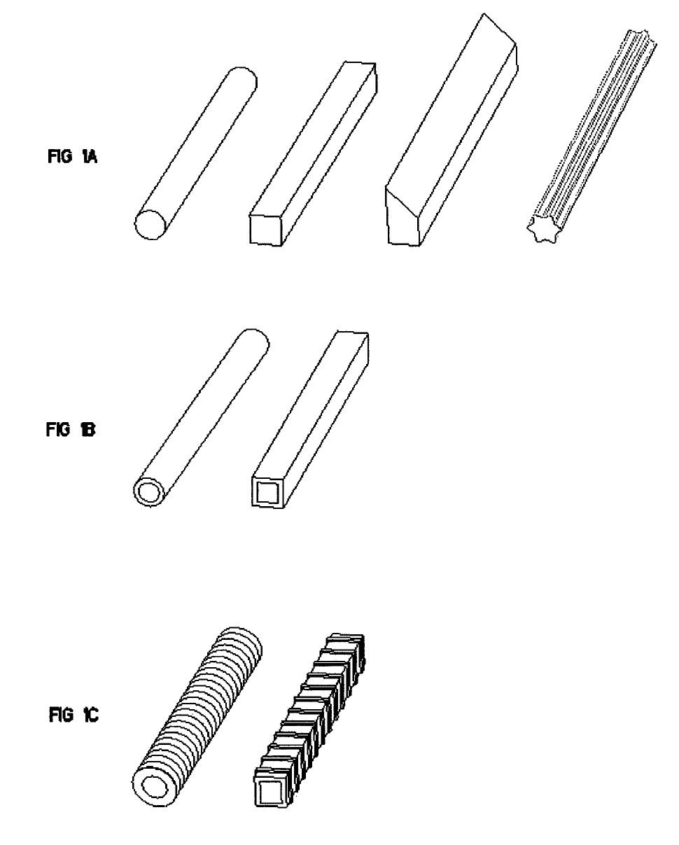

A pultrusion process where continuous fibers such as glass, carbon, aramid, steel or other high stiffness fibers are pulled through a die in which the fibers are impregnated with a resin and the resin-fiber combination is shaped into a profile can be used to manufacture these continuous fiber composite profiles of any suitable cross-sectional shape. FIG. 1A shows a few examples of such shapes. The pultrusion method can be any existing method known in the art for thermoset resins such as that described by Goldsworthy in U.S. Pat. No. 3,769,127 or for thermoplastics methods such as a means of melt pultrusion as described by Hawley in U.S. Pat. No. 4,439,387. The resin may be of any type, thermoplastic or thermoset however it is preferable to use a resin which will have good compatibility with the matrix resin of the synthetic wood. For example, if the synthetic wood matrix resin is polypropylene it is preferable to use polypropylene as the matrix resin for the pultrusion. Thermoplastic composite rods may also be made by pultruding co-mingled fibers of glass and thermoplastic such as those supplied by Vetrotex under the tradename Twintex.

The continuous fiber profiles can be incorporated into the synthetic wood by feeding them into holes or slots in the die used for extruding the synthetic wood profile. Preferably the continuous fiber profiles would be fed in continuous lengths from a roll. The amount of composite used (either number of rods or cross sectional area of the rods) in a given synthetic wood profile can be varied to suit the properties of the synthetic wood and expected loading conditions for the component. If a molded component rather than an extruded synthetic wood component is to be made it can be reinforced with the continuous fiber profiles by inserting them into the injection molding die used for molding the components.

The thermoplastic composite rods can also be formed in-situ during the extrusion process for the synthetic wood by introducing co-mingled fibers directly into the die during the extrusion process. In this way the heat and pressure of the synthetic wood in the die consolidate the co-mingled fibers into a continuous fiber composite reinforcement within the synthetic wood.

The thermoplastic composite rods can also be formed in-situ during the extrusion process for the synthetic wood by introducing pre-heated fibers directly into the die during the extrusion process. In this way the heat of the fibers the heat and pressure of the synthetic wood in the die bond the matrix of the synthetic to the fibers to form a continuous fiber reinforcing element within the synthetic wood.

In an alternative version of the invention, the continuous fiber profile can be over-extruded with a layer of a second resin. FIG. 1B shows two examples of such over-extruded continuous fiber profiles. This over-extrusion can preferably be carried out in line with the pultrusion. This second resin can be chosen to have good compatibility with both the matrix resin of the synthetic wood and the matrix resin of the continuous fiber composite. In this way the overextruded layer can be used as a compatibilizer between the resin in the synthetic wood and the resin in the continuous fiber composite if they are different. This over-extruded continuous fiber composite is incorporated into the synthetic wood by feeding into holes or slots in the synthetic wood extrusion die as previously described.

In a further alternative version of the invention the over-extruded second layer of resin can have surface perturbations formed into its surface in a knurling or forming process performed in line with the overextrusion process while the overextruded resin is still hot enough to be formed. FIG. 1C shows two examples of such surface perturbed over-extruded continuous fiber profiles. The surface perturbations thus formed create a mechanical interlock with the extruded synthetic wood and aid the stress transfer between the synthetic wood and the composite. It may be advantageous for the overextruded second layer to be a filled polymer e.g. a glass filled or wood fiber filled polymer. This has the advantage of helping distribute the stresses between the strong, stiff composite and the weaker, more flexible synthetic wood. This over-extruded continuous fiber composite with surface perturbations is incorporated into the synthetic wood by feeding into holes or slots in the synthetic wood extrusion die as previously described.

The continuous fiber profile can have any convenient cross-sectional shape. For example it can be circular or rectangular, as these are easiest to pultrude. It can be advantageous to have a more complex shaped profile such as a star shape, ‘I’ section or ‘U’ channel as these would have greater cross sectional area to bond with the synthetic wood. It can also be advantageous to make the composite profile a tapered shape to deflect nails and prevent them being driven directly into the composite. It may also be advantageous to use a hollow continuous fiber composite profile to reduce weight.

In a further alternative version of the invention the matrix for the continuous fiber composite can be a recycled thermoplastic. This has the advantage of reducing the cost of the pultruded composite and of increasing the environmental acceptability of the product.

The above alternatives offer the possibility to manufacture an enhanced synthetic wood with properties adequate to be used for a complete deck, including thus eliminating the problems of deterioration of the wood and potential health hazards of chemically treated lumber in all components of the deck.

A further aspect of the invention relates to the method of joining the synthetic wood components. Usually wood components are jointed by means of bolts, screws or nails however these have the disadvantage of being prone to corrosion and impairing the subsequent recyclability of the complete deck. Bolts and screws also have the disadvantage of being time consuming to install.

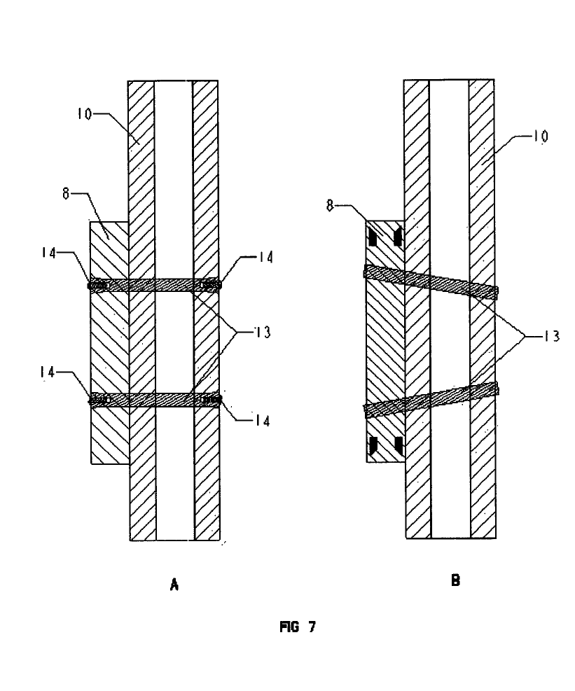

Referring now to FIG. 7, the synthetic wood components (8) and (10) can be jointed to each other by drilling aligned holes in both pieces and force fitting dowels (13) made from continuous fiber reinforced composite into the holes for example by driving them in with a hammer. The size and number of the composite dowels is determined by the loads that the joint needs to carry. For example the dowels used to fasten a structural joist would be larger than those used to fasten an aesthetic fascia. The composite dowels can be either a simple circular cross section or have a fluted surface (like existing woodwork dowels) to enhance grip. The continuous fiber reinforced composite dowels can be manufactured by the same pultrusion processes as for the composite reinforcing profiles. The bond may be further enhanced if desired by the use of a suitable adhesive, either pre-applied to the dowels or applied to the hole before the dowel is driven home. The security of the doweled joint can be further enhanced by drilling the holes and driving the dowels (13) at a slight angle to each other (FIG. 7B) such that they will resist side loads which may otherwise cause the dowel joints to loosen. A second way to enhance the security of the doweled joints is to drive a small screw or nail (14) into the center of each end of the dowel once it is has been installed (FIG. 7A). This causes the dowel to expand and creates a wedge effect that prevents the joint working loose. The dowels may be pre-manufactured to standard lengths and have a starter hole drilled for the screw.

It should be noted that although the description and examples focus on the use of composite reinforced synthetic lumber for decks there are many other applications where such an enhanced synthetic lumber would have potential use. These include signs, sign posts, highway guardrail posts, architectural retaining walls, garden structures, playground structures, house siding, benches, furniture, automotive components, fencing, railings, picnic tables, mailbox posts, speedbumps, walkways, marker posts, pallets, crates, pilings, marinas, landscape timbers, docks, barricades, workbenches, trim and fascias and the like.

### EXAMPLE 1

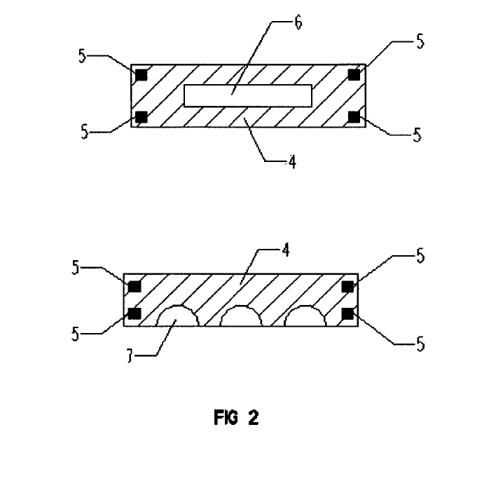

Referring now to FIG. 2, a deck board (4) of nominal cross sectional dimensions 2″×6″ or 5/4″×6″ is extruded from a synthetic wood such as for example a wood fiber filled recycled polyethylene. The deck board has four square rods of continuous fiber composite (5) positioned approximately ¼″ away from the outer surfaces. The rods are ¼″ square and are made from pultruded continuous glass fibers with a matrix of recycled polyethylene. The rods have a modulus of elasticity of approximately 5 million psi. The addition of the rods causes the bending stiffness of the boards to increase from approximately 300,000 psi to around 700,000-800,000 psi when measured with the 6″ dimension of the board horizontal (i.e. as a deck board would normally be used). The boards may have hollow sections (6) to reduce weight or a scalloped external face (7) on one side to reduce weight and enhance drainage with relatively little effect on their modulus. On the top surface it may be desirable to incorporate shallow ribs or other texture for grip.

### EXAMPLE 2

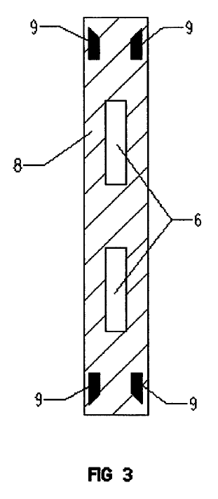

Referring now to FIG. 3, a joist or header (8) of cross sectional dimensions 2″×10″ is extruded from a synthetic wood fiber filled polypropylene. The joist has four trapezoidal composite rods (9) inserted into it during the extrusion process approximately ¼″ in from the outer surfaces. The total cross sectional area of the rods is approximately 0.875 sq. inches. The rods are made by pultruding continuous rovings of glass fibers commingled with polypropylene fibers. The rods have a modulus of approximately 5.5 million psi. The addition of the rods causes the bending stiffness of the joist or header to increase from approximately 600,000 psi to around 1.4 million psi when measured with the 10″ dimension of the joist vertical (i.e. as it would be normally loaded for a joist). The joist may have hollow sections (6) to reduce weight with relatively little effect on its modulus.

### EXAMPLE 3

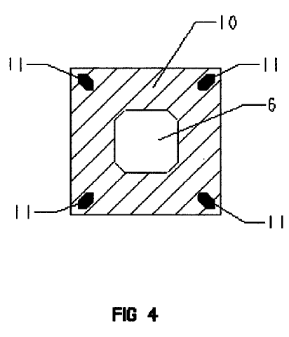

Referring now to FIG. 4, a 4″ square post (10) is extruded from a synthetic wood fiber filled recycled polypropylene. The post has four trapezoidal composite rods (11) inserted into it during the extrusion process approximately ¼″ in from the outer surfaces. The total cross sectional area of the rods is approximately 0.75 sq. inches. The rods are made by pultruding continuous rovings of glass fibers commingled with polypropylene fibers. The rods have a modulus of approximately 5.5 million psi. The addition of the rods causes the bending stiffness of the posts to increase from approximately 600,000 psi to around 1.4 million psi when measured in either direction since posts are likely to be loaded in bending in either direction due to their function in supporting the deck. The post may be hollowed out in the center to reduce weight with relatively little effect on its modulus.

### EXAMPLE 4

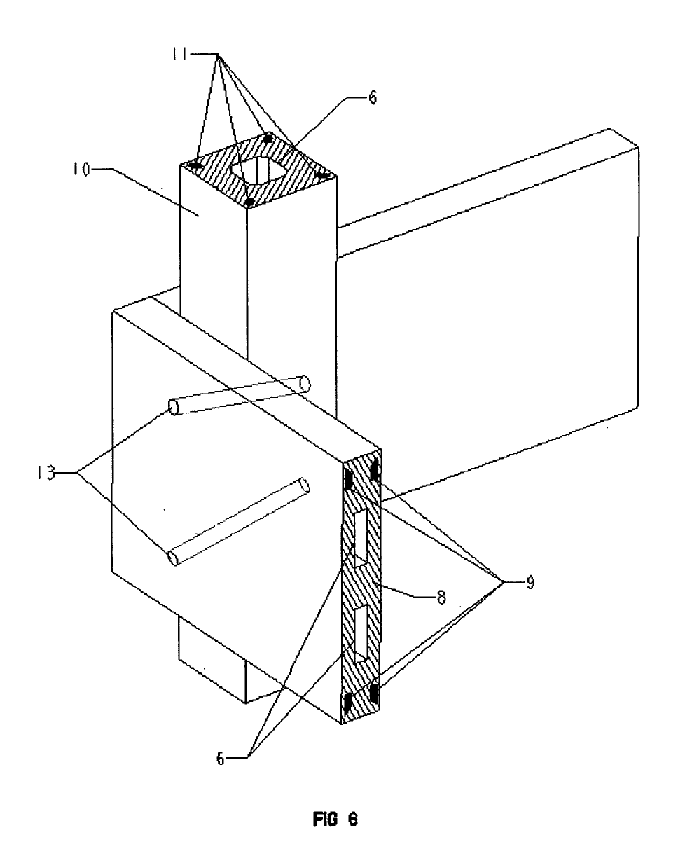

Referring now to FIG. 6, the 2″×10″ joist or header (8) of FIG. 3 is joined to the 4″×4″ post (10) of FIG. 4 by drilling holes and driving in composite dowels (13) to rigidly join the two pieces.

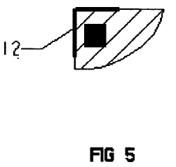

In examples 1, 2, 3 the shape of the extruded component may be modified for example by slightly rounding corners for ease of production. Referring now to FIG. 5, it may be desirable to incorporate a feature such as a slightly raised or textured surface (12) to indicate areas where it is desirable to avoid the use of nails.

The sections shown all contain symmetrical reinforcement. This is usually desirable since it is difficult to guarantee which way up a joist will be installed. However it should be understood that in some instances it may be desirable to incorporate unsymmetrical amounts of reinforcement—i.e. either more composite rods or composite rods of greater cross sectional area in one edge of a beam to deal most effectively with various load conditions.

What is claimed is:

1. A synthetic wood structural member, comprising: a synthetic wood body comprising a synthetic polymer, the synthetic wood body having a longitudinal axis; at least one continuous fiber composite reinforcing rod element positioned within the synthetic wood body to increase the stiffness of the synthetic wood structural member, the at least one continuous fiber composite reinforcing rod element having a longitudinal axis, the longitudinal axis of the at least one continuous fiber composite reinforcing element being essentially parallel to the longitudinal axis of the synthetic wood structural member.

2. The improved synthetic wood structural member of claim 1 where the continuous fiber composite reinforcing rod element is manufactured by pultrusion.

3. The improved synthetic wood structural member of claim 1 where the continuous fiber composite reinforcing rod element has a matrix of a thermoset resin.

4. The improved synthetic wood structural member of claim 1 where the continuous fiber composite reinforcing rod element has a matrix of virgin or recycled thermoplastic resin.

5. The improved synthetic wood structural member of claim 2 where the continuous fiber composite reinforcing rod element has a surface applied during pultrusion to aid mechanical or chemical bond to the synthetic wood.

6. The improved synthetic wood structural member of claim 5 where the surface applied to the continuous fiber composite reinforcing rod element is achieved by over extrusion of a polymer compatible with both the synthetic wood and the composite.

7. The improved synthetic wood structural member of claim 5 where the over-extruded layer has deformations formed into the surface to create a mechanical key with the extruded synthetic wood.

8. The improved synthetic wood structural member of claim 1 where the synthetic wood structural member is a recycled polyethylene, polypropylene or polyvinylchloride.

9. The improved synthetic wood structural member of claim 1 where the synthetic wood structural member is a thermoplastic filled with wood fibers or particles or other natural fibers.

10. The improved synthetic wood structural member of claim 1 where the synthetic wood structural member is filled with discontinuous glass fibers or other artificial fibers or particles.

11. A deck board, joist, header or post made from the synthetic wood structural member according to claim 1.

12. A deck made with one or more of the improved synthetic wood structural members of claim 11.

13. A sign, sign post, highway guardrail post, architectural retaining wall, garden structure, playground structure, house siding, bench, article of furniture, automotive component, fence, fence post, railing, picnic table, mailbox post, speedbump, walkway, marker post, pallet, crate, piling, marina, landscape timber, dock, barricade, workbench, or piece of trim or piece of fascia made from the synthetic wood structural member of claim 1.

14. A cylindrical dowel comprising a synthetic resin matrix containing continuous fibers, the continuous fibers being essentially parallel to the longitudinal axis of the dowel and uniformly distributed in the matrix, used in jointing two or more pieces of wood, synthetic wood, or continuous fiber reinforced synthetic wood.

15. A deck assembled with the dowels of claim 14.

16. A sign, sign post, highway guardrail post, architectural retaining wall, garden structure, playground structure, house siding, bench, article of furniture, automotive component, fence, fence post, railing, picnic table, mailbox post, speedbump, walkway, marker post, pallet, crate, piling, marina, landscape timber, dock, barricade, workbench, or piece of trim or piece of fascia assembled or held in place with the dowels of claim 14.

17. An improved synthetic wood structural member of the type that comprises a synthetic polymer, the synthetic wood structural member having a longitudinal axis, wherein the improvement comprises: at least one continuous fiber composite reinforcing rod element positioned within the synthetic wood structural member to increase the stiffness of the improved synthetic wood structural member, the at least one continuous fiber composite reinforcing rod element having a longitudinal axis, the longitudinal axis of the at least one continuous fiber composite reinforcing rod element being essentially parallel to the longitudinal axis of the improved synthetic wood structural member.
